(19) United States
(12) Patent Application Publication
(10) Pub. No.: US 2025/0315968 A1
(43) Pub. Date: Oct. 9, 2025

(54) METHOD AND DEVICE WITH DEPTH MAP GENERATION USING FOCUS STACK DATA

(71) Applicant: Samsung Electronics Co., Ltd., Suwon-si (KR)

(72) Inventors: Lijuan JIAO, Xi’an (CN); Min ZHENG, Xi’an (CN); Yuguang LI, Xi’an (CN); Hana LEE, Suwon-si (KR); Myungsub CHOI, Suwon-si (KR); Pei YOU, Xi’an (CN)

(73) Assignee: Samsung Electronics Co., Ltd., Suwon-si (KR)

(21) Appl. No.: 19/170,271

(22) Filed: Apr. 4, 2025

(30) Foreign Application Priority Data
Apr. 8, 2024 (CN) 202410419825.0
Oct. 15, 2024 (KR) 10-2024-0140374

(51) Int. Cl. G06T 7/571

(52) U.S. Cl. CPC G06T 7/571; G06T 2207/20081; G06T 2207/20221

(57) ABSTRACT

A method and device with depth map generation using focus stack data are provided. The electronic device includes one or more processors respectively comprising processing circuitry, and a memory storing code, which upon execution by the one or more processors, configures the one or more processors to generate focus stack data including images collected by an image collection device having a plurality of different focal lengths for a same scene at a plurality of viewing angles, generate a depth map for each of the images included in the generated focus stack data, by merging depth maps corresponding to an individual viewing angle among the generated depth maps, generate a single depth map for the individual viewing angle, and by processing and merging depth information of single depth maps generated corresponding to the plurality of viewing angles, generate a final depth map for the same scene.

### CROSS-REFERENCE TO RELATED APPLICATIONS

This application claims the benefit under 35 USC § 119 (a) of Chinese Patent Application No. 202410419825.0, filed on Apr. 8, 2024, in the China National Intellectual Property Administration, and Korean Patent Application No. 10-2024-0140374, filed on Oct. 15, 2024, in the Korean Intellectual Property Office, the entire disclosures of which are incorporated herein by reference for all purposes.

### BACKGROUND

### 1. Field

The following description relates to a method and device with depth map generation using focus stack data.

### 2. Description of Related Art

The rapid development of electronic devices, including smartphones and digital cameras, has significantly heightened user expectations for image-capturing technologies. In photography, autofocus capabilities play a very important role, as both the sharpness of captured images and the speed of focus acquisition critically influence user experience.

Deep learning has recently demonstrated exceptional performance in various fields. Within autofocus development, learning-based autofocus methods utilizing deep neural networks have gained prominence. Such approaches depend on high-quality training data-specifically, comprehensive and reliable depth maps—to effectively train autofocus models for optimizing imaging device performance.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes one or more processors comprising processing circuitry; and a memory storing executable code that, when executed by the one or more processors, configures the one or more processors to: generate focus stack data including images collected by an image collection device at a plurality of viewing angles, each image of the images associated with a distinct focal length for a same scene; generate a depth map for each image of the images included in the generated focus stack data; by merging depth maps corresponding to an individual viewing angle among the generated depth maps, generate a single depth map for the individual viewing angle; and by processing and merging depth information of single depth maps generated corresponding to the plurality of viewing angles, generate a final depth map for the same scene.

The execution of the code by the one or more processors may further configure the one or more processors to: calculate a first reference value based on order information of depth values of a same pixel identified in the depth maps corresponding to the individual viewing angle; and by determining the calculated first reference value as a depth value for the same pixel of the single depth map, generate the single depth map for the individual viewing angle.

The execution of the code by the one or more processors may further configure the one or more processors to: align the depth values of the same pixel identified in size order; and in response to “N” depth values aligned in the size order being odd, determine a depth value located in the middle of a sequence of the depth values as the first reference value.

The execution of the code by the one or more processors may further configure the one or more processors to, in response to “N” depth values aligned in the size order being even, determine the first reference value using an N/2-th depth value and an (N/2)+1-th depth value in the sequence of the depth values.

The execution of the code by the one or more processors may further configure the one or more processors to calculate confidence of the depth value determined for the same pixel of the single depth map by dividing a number of a depth value in which a difference from the first reference value is within an allowable error, among the depth values of the same pixel identified in each of the depth maps corresponding to the individual viewing angle, by a number of total depth values identified in the same pixel.

The execution of the code by the one or more processors may further configure the one or more processors to: calculate a second reference value based on frequency information of depth values of a same pixel identified in the depth maps corresponding to the individual viewing angle; and by determining the calculated second reference value as a depth value for the same pixel of the single depth map, generate the single depth map for the individual viewing angle.

The execution of the code by the one or more processors may further configure the one or more processors to calculate confidence of the depth value determined for the same pixel of the single depth map by dividing a number of depth values in which a difference from the second reference value is within an allowable error, among the depth values of the same pixel identified in each of the depth maps corresponding to the individual viewing angle, by a number of total depth values identified in the same pixel.

The execution of the code by the one or more processors may further configure the one or more processors to: generate the final depth map for the same scene; generate a plurality of planes with different depth levels by sampling the single depth map for the individual viewing angle; for each of the generated planes, determine a pixel connection area formed by a single pixel or two or more adjacent single pixels in which an object exists and a depth value is assigned; for each of the generated planes, delete a depth value for at least one single pixel included in a pixel connection area that satisfies a preset condition; and update the single depth map corresponding to the individual viewing angle by merging planes in which the depth value for at least one single pixel is deleted.

The execution of the code by the one or more processors may further configure the one or more processors to: identify a common visibility area observed in common at the plurality of viewing angles in the updated single depth map corresponding to the individual viewing angle; remove remaining areas from the updated single depth map corresponding to the individual viewing angle, except for the common visibility area; and generate the final depth map by merging single depth maps corresponding to the individual viewing angle in which the remaining areas are removed.

The execution of the code by the one or more processors may further configure the one or more processors to generate a data set for training an autofocus system, based on the generated final depth map.

The execution of the code by the one or more processors may further configure the one or more processors to: divide the final depth map into a preset number of first image patches; based on confidence of a depth value of each pixel included in the final depth map, select at least one second image patch from the first image patches; and determine a depth value of the selected second image patch and a focal length of an image collection device corresponding to the depth value as a data set for training the autofocus system.

The execution of the code by the one or more processors may further configure the one or more processors to: identify a first pixel number in which the confidence of the depth value is greater than or equal to a preset value and a second pixel number in which the confidence of the depth value is less than the preset value, among pixels included in the first image patch; and in response to the first pixel number being greater than the second pixel number, select the corresponding first image patch as the second image patch.

In one general aspect, a processor-implemented method for operating an electronic device includes: generating focus stack data including images collected by an image collection device at a plurality of viewing angles, each image of the images associated with a distinct focal length for a same scene; generating a depth map for each image of the images included in the generated focus stack data; by merging depth maps corresponding to an individual viewing angle among the generated depth maps, generating a single depth map for the individual viewing angle; and by processing and merging depth information of single depth maps generated corresponding to the plurality of viewing angles, generating a final depth map for the same scene.

The generating of the single depth map for the individual viewing angle may include calculating a first reference value based on order information of depth values of a same pixel identified in the depth maps corresponding to the individual viewing angle; and by determining the calculated first reference value as a depth value for the same pixel of the single depth map, generating the single depth map for the individual viewing angle.

The method may further include: calculating confidence of a depth value determined for each pixel of the single depth map for the individual viewing angle, wherein the calculating of the confidence comprises calculating confidence of the depth value determined for the same pixel of the single depth map by dividing a number of depth values in which a difference from the first reference value is within an allowable error, among the depth values of the same pixel identified in each of the depth maps corresponding to the individual viewing angle, by a number of total depth values identified in the same pixel.

The generating of the single depth map for the individual viewing angle may include calculating a second reference value based on frequency information of depth values of a same pixel identified in the depth maps corresponding to the individual viewing angle; and by determining the calculated second reference value as a depth value for the same pixel of the single depth map, generating the single depth map for the individual viewing angle.

The method may further include calculating confidence of a depth value determined for each pixel of the single depth map for the individual viewing angle, wherein the calculating of the confidence comprises calculating confidence of the depth value determined for the same pixel of the single depth map by dividing a number of depth values in which a difference from the second reference value is within an allowable error, among the depth values of the same pixel identified in each of the depth maps corresponding to the individual viewing angle, by a number of total depth values identified in the same pixel.

The generating of the final depth map for the same scene may include generating a plurality of planes with different depth levels by sampling the single depth map for the individual viewing angle; for each of the generated planes, determining a pixel connection area formed by a single pixel or two or more adjacent single pixels; for each of the generated planes, deleting a depth value for at least one pixel included in a pixel connection area that satisfies a preset condition; and updating the single depth map corresponding to the individual viewing angle by merging planes in which the depth value for at least one pixel is deleted.

In one general aspect, provided is a non-transitory computer-readable storage medium storing instructions that, when executed by a processor, cause the processor to perform any one, any combination, or all operations or methods described herein.

In one general aspect, an electronic device includes one or more processors comprising processing circuitry; a memory connected to the one or more processor via a data bus and storing executable code that, when executed, configures the one or more processors to: generate focus stack data including images captured at a plurality of viewing angles, each image associated with a distinct focal length for a scene; generate a depth map for each image in the focus stack data; merge depth maps corresponding to a single viewing angle to generate a consolidated depth map for the single viewing angle; and aggregate depth information from the consolidated depth maps across the plurality of viewing angles to generate a final depth map for the scene; and a transceiver configured to establish communication channels between the one or more processors and the memory and between the electronic device and an external device.

Other features and aspects will be apparent from the following detailed description, the drawings, and the claims.

### BRIEF DESCRIPTION OF THE DRAWINGS

With regard to the description of the drawings, the same or similar reference numerals may be used to refer to the same or similar components.

FIG. 1 illustrates an example electronic device with depth map generation using focus stack data according to one or more embodiments.

FIG. 2 illustrates an example method with final depth map generation using an autofocus system according to one or more embodiments.

FIG. 3 illustrates an example process of performing sweep filtering on a single depth map generated corresponding to an individual viewing angle according to one or more embodiments.

FIG. 4 illustrates an example process of performing common visibility crop on single depth maps according to one or more embodiments.

FIG. 5 illustrates an example method of generating a data set for training an autofocus system using a final depth map according to one or more embodiments.

FIG. 6 illustrates an example method of automatically adjusting a focus of an image collection device through an autofocus system according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

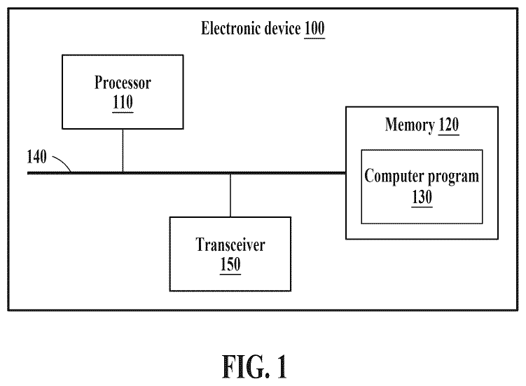

FIG. 1 illustrates an example electronic device with depth map generation using focus stack data according to one or more embodiments. An electronic device may include a processor (i.e., one or more processors) and a memory (i.e., one or more memories) that may store instructions, which when executed by the processor configure the processor to perform one or more or all operations or methods described herein. As a non-limiting example, the electronic device may correspond to the electronic device 100, and the processor and the memory may correspond to the processor 110 and memory 120 of FIG. 1.

Referring to FIG. 1, the electronic device 100 may include one or more processors 110 and the memory 120 for loading or storing a computer program 130 executed by the one or more processors 110. The one or more processors 110 and the memory 120 may be connected to each other via a communication link 140 (e.g., a bus). In an example, the electronic device 100 may further include a transceiver 150. The transceiver 150 may be configured to establish communication channels between the electronic device 100 and an external device and/or between the one or more processors 110 and the memory 120, for data exchange including transmission and/or reception of image data between the electronic device 100 and another electronic device (e.g., an image collection device described below). The components included in the electronic device 100 of FIG. 1 are just an example, and one of ordinary skill in the art may understand that general components other than the components shown in FIG. 1 may be further included.

The one or more processors 110 respectively comprise processing circuitry configured to control the overall operation of each component of the electronic device 100. In an example, the processor 110 may include at least one of a central processing unit (CPU), a microprocessor unit (MPU), a microcontroller unit (MCU), a graphics processing unit (GPU), a neural processing unit (NPU), a digital signal processor (DSP), and other well-known types of processors in a relevant technical field of the present disclosure. In addition, the processor 110 may perform an operation on the computer program 130 or at least one application to execute a method and/or an operation according to various examples of the present disclosure.

The memory 120 is a non-transitory computer-readable storage medium, which is/are configured to temporarily and/or permanently store one or a combination of two or more of various pieces of data, commands, or information used by a component (e.g., the processor 110) included in the electronic device 100. The memory 120 may include volatile memory and/or non-volatile memory.

The computer program 130, stored in the memory 120, may include software-implemented modules configured to execute the methods described in one or more embodiments. In an example, these modules may correspond to executable commands or routines within the program 130. For example, the program 130 may include instructions (i.e., executable code) to perform generating focus stack data including multiple images of the same scene captured/collected by an image collection device at multiple viewing angles, where each image set at a given angle includes varying focal lengths, generating a depth map for each image within the generated focus stack data, by merging depth maps corresponding to an individual viewing angle among the generated depth maps, generating a single consolidated depth map for the individual viewing angle, and by processing and integrating/merging depth information from the consolidated depth maps across all of the plurality of viewing angles, generating a final unified depth map for the same scene.

When the computer program 130 is loaded to the memory 120, the processor 110 may execute various methods and/or operations according to various examples of the present disclosure by executing a plurality of operations to implement the program 130.

The communication link 140 may include a path to transmit various pieces of data, commands, and information among components included in the electronic device 100. In an example, the communication link 140 may be a peripheral component interconnect (PCI) bus or an extended industry standard architecture (EISA) bus. However, the type of bus is an example and not limited thereto. For example, a bus is illustrated by a single line for ease of description in FIG. 1, but a plurality of buses or various types of buses may be included.

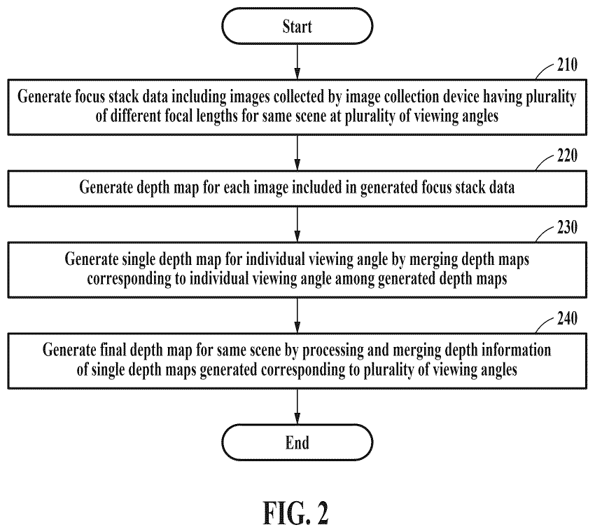

FIG. 2 illustrates an example method for generating a final depth map using an autofocus system according to one or more embodiments. In an example, one or more operations illustrated in FIG. 2 may be performed simultaneously or in parallel with another operation, and the order of the operations may be changed. In addition, at least one of the operations may be omitted or another operation may be additionally performed. The method of FIG. 2 may be implemented by one or more components of an electronic device (e.g., the electronic device 100 of FIG. 1), including one or more processors operatively coupled to a memory and an image collection/capture device.

According to one embodiment, the auto-focus system may comprise a hardware or software-implemented mechanism configured to automatically adjust a focal configuration (e.g., focus) of an image collection device. The image collection device may be integrated into, or communicatively coupled to, an electronic device (e.g., the electronic device 100 of FIG. 1). Non-limiting examples of such image collection devices may include cameras, microscopes, telescopes, or other optical imaging systems.

Referring to FIG. 2, in operation 210, a processor of an electronic device (e.g., the processor 120 of FIG. 1) may acquire or generate focus stack data including a plurality of images of a static scene captured/collected by an image collection device. The focus stack data includes images acquired at a plurality of distinct viewing angles (e.g., M viewing angles) and a plurality of discrete focal lengths (e.g., N focal lengths) per viewing angle. For instance, the focus stack data may comprise M×N images (e.g., 5×6=30 images), where M corresponds to the number of viewing angles and N to the number of focal lengths per viewing angle.

In operation 220, the processor may generate a depth map for each image within the obtained/generated focus stack data. In an example, a depth map may refer to a two-dimensional image that represents the distance between an object in an image collected by an image collection device and the image collection device, and each pixel value in the depth map may represent the distance between an object corresponding to a corresponding pixel in an image collected by an image collection device and the image collection device. In one implementation, pixel values in the depth map are inversely proportional to the distance, such that a higher pixel value in the depth map may represent that the object is closer to the image collection device, and a lower pixel value may represent that the object is farther away from the image collection device.

According to one embodiment, the processor may generate a depth map for each image of the images included in the focus stack data, based on a structure from motion (SFM) algorithm or a multiple view stereo (MVS) algorithm. The SFM algorithm is technology of analyzing two-dimensional (2D) images captured according to movements of a camera of the image collection device and restoring a three-dimensional (3D) structure by analyzing relative camera displacements inferred from two-dimensional image sequences. The MVS algorithm restores a 3D structure from images captured at different fixed viewing angles. These algorithms are provided as non-limiting examples, and other depth estimation techniques may be substituted without departing from the scope of the invention.

During image acquisition (e.g., an actual capturing process), a spatial relationship between the object in the scene and the image capture device may remain static. For example, a position of the object in the scene and a position of the camera within the same scene may not change, with only the focal length of the image collection device varying across the plurality of images. Consequently, only one depth map may be required for a same viewing angle in the same scene.

Accordingly, in operation 230, by merging depth maps corresponding to an individual viewing angle among the generated depth maps, the processor may obtain/generate a unified single depth map for the individual viewing angle. For example, the processor may apply computational fusion techniques to merge N depth maps (corresponding to N focal lengths) for each of the M viewing angles, thereby generating M unified single depth maps. In one implementation, the fusion process employs multi-focus image fusion methodologies to optimize depth accuracy and reduce noise.

More specifically, the processor may merge depth maps generated corresponding to individual viewing angles into a single depth map using statistical merging. In an example, the processor may calculate a first reference value based on order information of depth values of a same pixel identified in the depth maps corresponding to the individual viewing angles and may merge the depth maps into the single depth map based on the calculated first reference value. Here, the first reference value may refer to a depth value located in the middle (e.g., a middle value) when the depth values of the same pixel are aligned in size order.

For example, the processor may extract the depth values for the same pixel from the “N” depth maps generated corresponding to any one of the individual viewing angles and may align the depth values in the size order. The processor may then calculate the middle value of the aligned depth values and may determine the calculated middle value as the depth value for the same pixel in the single depth map.

Here, when N is an odd number, the processor may determine the depth value of the single depth map by selecting the depth value located in the middle of a sequence of “N” depth values aligned in the size order as the middle value.

Alternatively, when N is an even number, the processor may determine the depth value of the single depth map by calculating, as the middle value, an average of an N/2-th depth value and an (N/2)+1-th depth value in a sequence of the “N” depth values aligned in the size order.

According to one embodiment, the processor may calculate confidence (e.g., conf) for the depth value of such generated single depth map using Equation 1 below.

$$\begin{matrix}\{ \begin{matrix}\begin{matrix}1 , & \frac{‖ {d}_{m e d i a n} - d [ j ] \vert}{{d}_{m e d i a n}} < λ , i = 0 … N - 1\end{matrix} \\ 0 , etc .\end{matrix} \\ conf = \frac{{\sum }_{i = 0}^{N - 1} {s}_{i}}{N} , i = 0 … N - 1\end{matrix} \qquad Equation 1$$

Here, d[j] denotes a depth value of the same pixel identified in a j-th depth map among the “N” depth maps, d_{median} denotes the middle value for the depth values of the same pixel identified in the “N” depth maps, and λ denotes an empirical threshold value for an allowable error of the depth values.

Referring to Equation 1, the processor may calculate confidence of the depth value determined for the same pixel of the single depth map by dividing the number of depth values in which the difference from the middle value is within an allowable error, among the depth values of the same pixel identified in the “N” depth maps, by the number of total depth values identified in the same pixel. Here, the calculated confidence may have a value between 0 and 1, and the more depth values in which the difference from the middle value is within the allowable error, the higher the confidence of the depth value determined for the corresponding same pixel.

Accordingly, the processor may determine the depth value of the single depth map corresponding to the individual viewing angle through a statistical index based on the middle value and may provide a basis for a user to determine the accuracy of the corresponding single depth map by calculating the confidence of the determined depth value.

According to one embodiment, the processor may calculate a second reference value based on frequency information of the depth values of the same pixel identified in the depth maps corresponding to the individual viewing angle and may merge the depth maps into the single depth map based on the calculated second reference value. Here, the second reference value may refer to the most frequently observed depth value (e.g., mode) among the depth values of the same pixel.

For example, the processor may extract the depth values for the same pixel from the “N” depth maps generated corresponding to any one of the individual viewing angles and may determine the most frequently observed mode among the extracted depth values as the depth value for the same pixel in the single depth map.

According to one embodiment, the processor may calculate the confidence for the depth value of such a generated single depth map using Equation 2 below.

$$\begin{matrix}\{ \begin{matrix}\begin{matrix}1 , & \frac{\vert d [ i ] - d [ j ] \vert}{d [ i ]} < λ , i = 0 … N - 1\end{matrix} \\ 0 , etc .\end{matrix} \\ conf = \frac{{\sum }_{i = 0}^{N - 1} {s}_{i}}{N} , i = 0 … N - 1\end{matrix} \qquad Equation 2$$

Here, d[j] denotes the depth value of the same pixel identified in a j-th depth map among the “N” depth maps, and d[i] denotes the mode among the depth values of the same pixel identified in the “N” depth maps.

Referring to Equation 2, the processor may calculate confidence of the depth value determined for the same pixel of the single depth map by dividing the number of depth values in which the difference from the mode is within an allowable error, among the depth values of the same pixel identified in the “N” depth maps, by the number of total depth values identified in the same pixel. Similarly, the calculated confidence may have a value between 0 and 1, and the more depth values in which the difference from the mode is within the allowable error, the higher the confidence of the depth value determined for the corresponding same pixel.

In operation 240, the processor may generate the final depth map for the same scene by processing and merging depth data/information acquired from a plurality of single depth maps, each corresponding to a distinct viewing angle. According to one embodiment, the processor, prior to merging, may perform filtering operations on each individual depth map generated from a corresponding individual viewing angle to enhance data fidelity and remove unnecessary information or noise.

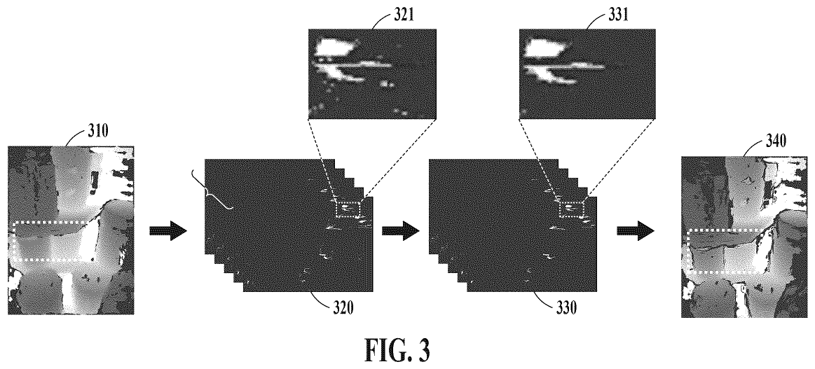

Referring to FIG. 3, a process of performing a sweep filtering operation on a single depth map 310 generated corresponding to an individual viewing angle is described. The processor may sample the single depth map 310 to generate a plurality of planes 320 according to different depth levels. For example, the processor may sample the single depth map 310 to generate “256” different planes 320 according to different focal distances between 0.1 meters (m) and 100 m. However, the number of planes generated through such a sampling process is only an example and not limited to the above example.

The processor may select/determine a pixel connection area for each of the generated planes 320. Here, the pixel connection area may refer to an area formed by a single pixel or two or more adjacent single pixels in which an object exists, and a depth value is assigned in the generated planes 320.

The processor may delete a depth value corresponding to at least one single pixel included in a pixel connection area that satisfies a preset condition among the selected/determined pixel connection areas. For example, the processor may delete the depth value of the single pixel for a pixel connection area in which the number of single pixels among the selected/determined pixel connection areas for each of the generated planes 320 is less than a preset standard. Comparing a plane 321 before the sweep filtering operation of FIG. 3 to a plane 331 after the sweep filtering operation, it may be confirmed that the depth values of the single pixels for the pixel connection area that are less than the preset standard in the plane 321 before the sweep filtering are deleted in the plane 331 after the sweep filtering operation.

The processor may generate a more precise depth map by merging planes 330, on which the sweep filtering operation is performed, into a final single depth map 340, thereby removing unnecessary detailed information of the single depth map 340 to enhance the accuracy (e.g., data fidelity) thereof.

Returning to FIG. 2, the processor may improve the accuracy of the final depth map by merging the single depth maps on which the swept filtering operation is performed, leaving only the same area visible from the plurality of viewing angles.

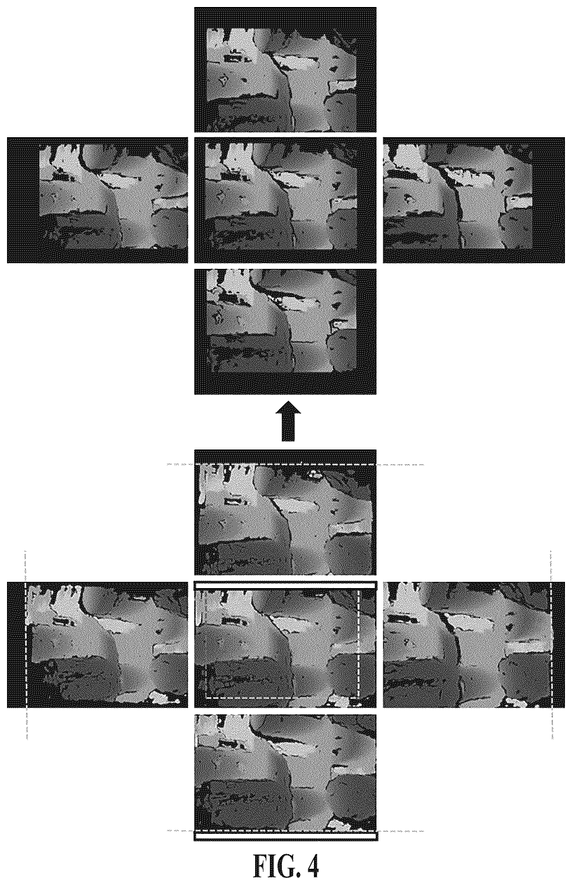

For example, referring to FIG. 4, a process of performing a common visibility crop on single depth maps is described. The processor may identify the common visibility area between a single depth map corresponding to one central viewing angle and single depth maps corresponding to four peripheral viewing angles. The processor may remove all areas from the single depth maps, leaving only the common visibility area.

In this method, the processor may generate the final depth map by merging the single depth maps corresponding to the peripheral viewing angles, leaving only the common visibility area, into the single depth map corresponding to the central viewing angle. Accordingly, the final depth map generated may provide more accurate depth values by including depth information for the common visibility area that is visible from all viewing angles, in addition to additional depth information that is visible from the individual viewing angles.

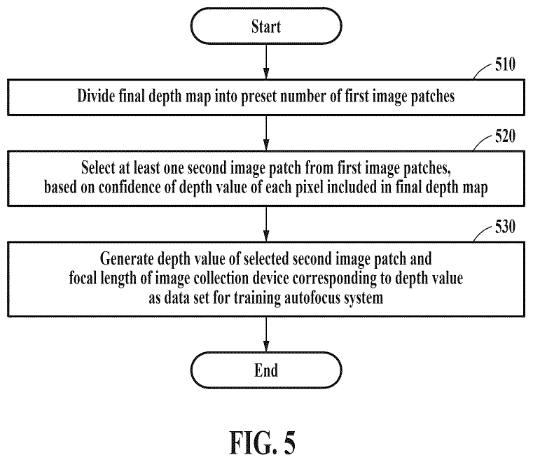

FIG. 5 illustrates an example method of generating a data set for training an autofocus system using a final depth map according to one or more embodiments. Operations illustrated in FIG. 5 may be executed concurrently, sequentially, or in a dynamically reordered sequence by at least one component of an electronic device (e.g., the electronic device 100 of FIG. 1). One or more operations may be omitted, substituted, or augmented without departing from the scope of the disclosed method.

Since a final depth map is generated based on a plurality of single depth maps generated corresponding to a plurality of viewing angles, a pixel included in the final depth map may correspond to a pixel included in the single depth maps. As described above, since the confidence of the pixels included in the single depth maps may be calculated, a processor may generate a final confidence map for the final depth map, based on the confidence of the pixels included in the single depth maps.

According to one embodiment, the processor of an electronic device (e.g., the processor 120 of FIG. 1) may generate a data set for training an autofocus system, based on the final confidence map for the final depth map.

In operation 510, the processor may divide the final depth map into a preset number of first image patches. For example, the processor may divide the final depth map into 3×3 first image patches, but such a method of dividing the final depth map is only an example and not limited to the above example.

In operation 520, the processor may select at least one second image patch from the first image patches, based on confidence of a depth value of each pixel included in the final depth map. In an example, the processor may identify a first pixel number in which the confidence of the depth value is greater than or equal to a preset value (e.g., 0.5) and a second pixel number in which the confidence of the depth value is less than the preset value, from among pixels included in the first image patch, based on the final confidence map. The processor may select the first image patch as the second image patch when the identified first pixel number is greater than the second pixel number.

In operation 530, the processor may determine a depth value of the selected second image patch and a focal length of an image collection device corresponding to the depth value as a data set for training the autofocus system. First, the processor may select a pixel with the maximum confidence from the pixels included in the second image patch, based on the final confidence map, and may determine the depth value of the selected pixel as the depth value of the corresponding second image patch.

According to one embodiment, the processor may generate/determine the focal length of the image collection device corresponding to the depth value of the second image patch using a plurality of focal lengths used when generating focus stack data corresponding to a central viewing angle. In an example, the processor may calculate a difference between the depth value of the second image patch and the plurality of focal lengths and may generate/determine a focal length in which the calculated difference is the minimum as a focal length corresponding to the depth value of the corresponding second image patch.

For example, when the depth value of the second image patch is a, and when each of the plurality of focal lengths used when generating the focus stack data corresponding to the central viewing angle is b1, b2, b3, b4, and b5, the processor may calculate the difference between the depth value of the second image patch and the plurality of focal lengths as a−b1, a−b2, a−b3, a−b4, and a−b5. When a−b1 is the minimum value, the processor may determine the focal length of the image collection device corresponding to the depth value of the second image patch as b1. The processor may combine and determine the depth value a of the second image patch and the focal length b1 of the image collection device as a data set for training an autofocus system.

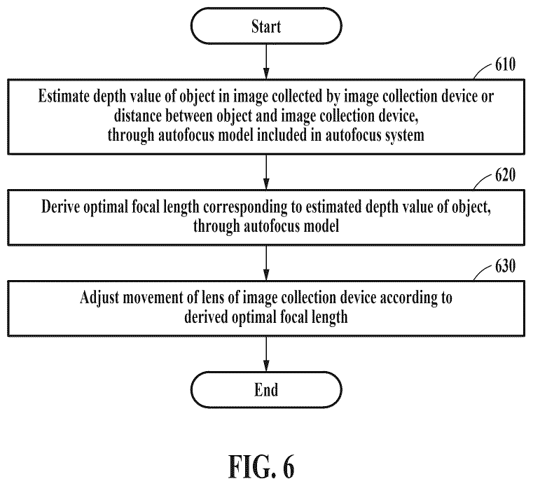

FIG. 6 illustrates an example method of automatically adjusting a focus of an image collection device through an autofocus system according to one or more embodiments. Operations depicted in FIG. 6 may be executed by at least one component of an electronic device (e.g., electronic device 100 of FIG. 1). The operations may be performed sequentially, concurrently, or in a dynamically reordered sequence, and one or more operations may be omitted, substituted, or supplemented without departing from the scope of the disclosed method.

In operation 610, a processor (e.g., the processor 120 of FIG. 1) of the electronic device may determine/estimate a depth value of an object within an image captured/collected by an image collection device or calculates a distance between the object and the image collection device. This determination/estimation is performed utilizing an autofocus model integrated into the autofocus system.

In operation 620, the processor may generate/derive an optimal focal length corresponding to the determined/estimated depth value of the object or distance, through the autofocus model. According to an example, the autofocus model may be trained based on a data set comprising various pieces of depth information and distance conditions and may be in a state where the autofocus model is trained in a method of adjusting the focus of the image collection device according to the depth value of the object or the distance between the object and the image collection device.

According to an example, the processor may also determine the focal length of the image collection device by referencing a separate lookup table. In an example, the processor may store a lookup table in which information on the focal length of the image collection device corresponding to the depth value of the object is recorded in advance and by referring to the lookup table, may generate/derive the focal length of the image collection device corresponding to the depth value of the object, enabling expedient and precise focal length derivation.

In operation 630, the processor may actuate a lens assembly within the image collection device to adjust the movement of lens of the image collection device according to the derived optimal focal length. This actuation optimizes optical alignment to achieve sharp focus on a target object.

The processors, memories, image collection devices/cameras, transceivers, communication links/buses, and electronic devices described herein, including descriptions with respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors comprising processing circuitry; and
a memory storing executable code that, when executed by the one or more processors, configures the one or more processors to:
generate focus stack data including images collected by an image collection device at a plurality of viewing angles, each image of the images associated with a distinct focal length for a same scene;
generate a depth map for each image of the images included in the generated focus stack data;
by merging depth maps corresponding to an individual viewing angle among the generated depth maps, generate a single depth map for the individual viewing angle; and
by processing and merging depth information of single depth maps generated corresponding to the plurality of viewing angles, generate a final depth map for the same scene.

2. The electronic device of claim 1, wherein
the execution of the code by the one or more processors further configures the one or more processors to:
calculate a first reference value based on order information of depth values of a same pixel identified in the depth maps corresponding to the individual viewing angle; and
by determining the calculated first reference value as a depth value for the same pixel of the single depth map, generate the single depth map for the individual viewing angle.

3. The electronic device of claim 2, wherein
the execution of the code by the one or more processors further configures the one or more processors to:
align the depth values of the same pixel identified in size order; and
in response to “N” depth values aligned in the size order being odd, determine a depth value located in the middle of a sequence of the depth values as the first reference value.

4. The electronic device of claim 3, wherein
the execution of the code by the one or more processors further configures the one or more processors to, in response to “N” depth values aligned in the size order being even, determine the first reference value using an N/2-th depth value and an (N/2)+1-th depth value in the sequence of the depth values.

5. The electronic device of claim 2, wherein
the execution of the code by the one or more processors further configures the one or more processors to calculate confidence of the depth value determined for the same pixel of the single depth map by dividing a number of a depth value in which a difference from the first reference value is within an allowable error, among the depth values of the same pixel identified in each of the depth maps corresponding to the individual viewing angle, by a number of total depth values identified in the same pixel.

6. The electronic device of claim 1, wherein
the execution of the code by the one or more processors further configures the one or more processors to:
calculate a second reference value based on frequency information of depth values of a same pixel identified in the depth maps corresponding to the individual viewing angle; and
by determining the calculated second reference value as a depth value for the same pixel of the single depth map, generate the single depth map for the individual viewing angle.

7. The electronic device of claim 6, wherein
the execution of the code by the one or more processors further configures the one or more processors to calculate confidence of the depth value determined for the same pixel of the single depth map by dividing a number of depth values in which a difference from the second reference value is within an allowable error, among the depth values of the same pixel identified in each of the depth maps corresponding to the individual viewing angle, by a number of total depth values identified in the same pixel.

8. The electronic device of claim 1, wherein
the execution of the code by the one or more processors further configures the one or more processors to:
generate the final depth map for the same scene;
generate a plurality of planes with different depth levels by sampling the single depth map for the individual viewing angle;
for each of the generated planes, determine a pixel connection area formed by a single pixel or two or more adjacent single pixels in which an object exists and a depth value is assigned;
for each of the generated planes, delete a depth value for at least one single pixel included in a pixel connection area that satisfies a preset condition; and
update the single depth map corresponding to the individual viewing angle by merging planes in which the depth value for at least one single pixel is deleted.

9. The electronic device of claim 8, wherein
the execution of the code by the one or more processors further configures the one or more processors to:
identify a common visibility area observed in common at the plurality of viewing angles in the updated single depth map corresponding to the individual viewing angle;
remove remaining areas from the updated single depth map corresponding to the individual viewing angle, except for the common visibility area; and
generate the final depth map by merging single depth maps corresponding to the individual viewing angle in which the remaining areas are removed.

10. The electronic device of claim 1, wherein
the execution of the code by the one or more processors further configures the one or more processors to generate a data set for training an autofocus system, based on the generated final depth map.

11. The electronic device of claim 10, wherein
the execution of the code by the one or more processors further configures the one or more processors to:
divide the final depth map into a preset number of first image patches;
based on confidence of a depth value of each pixel included in the final depth map, select at least one second image patch from the first image patches; and
determine a depth value of the selected second image patch and a focal length of an image collection device corresponding to the depth value as a data set for training the autofocus system.

12. The electronic device of claim 11, wherein
the execution of the code by the one or more processors further configures the one or more processors to:
identify a first pixel number in which the confidence of the depth value is greater than or equal to a preset value and a second pixel number in which the confidence of the depth value is less than the preset value, among pixels included in the first image patch; and
in response to the first pixel number being greater than the second pixel number, select the corresponding first image patch as the second image patch.

13. A processor-implemented method for operating an electronic device, the method comprising:
generating focus stack data including images collected by an image collection device at a plurality of viewing angles, each image of the images associated with a distinct focal length for a same scene;
generating a depth map for each image of the images included in the generated focus stack data;
by merging depth maps corresponding to an individual viewing angle among the generated depth maps, generating a single depth map for the individual viewing angle; and
by processing and merging depth information of single depth maps generated corresponding to the plurality of viewing angles, generating a final depth map for the same scene.

14. The method of claim 13, wherein
the generating of the single depth map for the individual viewing angle comprises:
calculating a first reference value based on order information of depth values of a same pixel identified in the depth maps corresponding to the individual viewing angle; and
by determining the calculated first reference value as a depth value for the same pixel of the single depth map, generating the single depth map for the individual viewing angle.

15. The method of claim 14, further comprising:
calculating confidence of a depth value determined for each pixel of the single depth map for the individual viewing angle,
wherein the calculating of the confidence comprises calculating confidence of the depth value determined for the same pixel of the single depth map by dividing a number of depth values in which a difference from the first reference value is within an allowable error, among the depth values of the same pixel identified in each of the depth maps corresponding to the individual viewing angle, by a number of total depth values identified in the same pixel.

16. The method of claim 13, wherein
the generating of the single depth map for the individual viewing angle comprises:
calculating a second reference value based on frequency information of depth values of a same pixel identified in the depth maps corresponding to the individual viewing angle; and
by determining the calculated second reference value as a depth value for the same pixel of the single depth map, generating the single depth map for the individual viewing angle.

17. The method of claim 16, further comprising:
calculating confidence of a depth value determined for each pixel of the single depth map for the individual viewing angle,
wherein the calculating of the confidence comprises calculating confidence of the depth value determined for the same pixel of the single depth map by dividing a number of depth values in which a difference from the second reference value is within an allowable error, among the depth values of the same pixel identified in each of the depth maps corresponding to the individual viewing angle, by a number of total depth values identified in the same pixel.

18. The method of claim 13, wherein
the generating of the final depth map for the same scene comprises:
generating a plurality of planes with different depth levels by sampling the single depth map for the individual viewing angle;
for each of the generated planes, determining a pixel connection area formed by a single pixel or two or more adjacent single pixels;
for each of the generated planes, deleting a depth value for at least one pixel included in a pixel connection area that satisfies a preset condition; and
updating the single depth map corresponding to the individual viewing angle by merging planes in which the depth value for at least one pixel is deleted.

19. A non-transitory computer-readable storage medium storing instructions that, when executed by a processor, cause the processor to perform the method of claim 13.

20. An electronic device comprising:
one or more processors comprising processing circuitry;
a memory connected to the one or more processors via a data bus and storing executable code that, when executed, configures the one or more processors to:
generate focus stack data including images captured at a plurality of viewing angles, each image associated with a distinct focal length for a scene;
generate a depth map for each image in the focus stack data;
merge depth maps corresponding to a single viewing angle to generate a consolidated depth map for the single viewing angle; and
aggregate depth information from the consolidated depth maps across the plurality of viewing angles to generate a final depth map for the scene; and
a transceiver configured to establish communication channels between the one or more processors and the memory and between the electronic device and an external device.
